(19) United States
(12) Patent Application Publication
(10) Pub. No.: US 2001/0027063 A1
(43) Pub. Date: Oct. 4, 2001

(54) Construction for preventing erroneous assembling of battery terminals, a battery and a set of terminals

(76) Inventors: Shigekazu Wakata, Yokkaichi-City (JP); Hideki Matsunaga, Yokkaichi-City (JP); Keiichi Itou, Aichi-ken (JP); Kazuyuki Shiraki, Aichi-ken (JP); Masanori Wakui, Aichi-ken (JP)

Correspondence Address: CASELLA & HESPOS, 274 MADISON AVENUE, NEW YORK, NY, 10016

(21) Appl. No.: 09/801,247

(22) Filed: Mar. 7, 2001

(30) Foreign Application Priority Data
Mar. 7, 2000 (JP) 2000-062439
Mar. 22, 2000 (JP) 2000-080121

(51) Int. Cl. H01R 13/64

(52) U.S. Cl. 439/680

(57) ABSTRACT

A battery (B) includes electrodes (11a, 11b) and engaging portions (10a, 10b) formed by recessing portions of the battery (B) around the electrodes (11a, 11b), and recesses (14a, 14b, 23a, 23b) are formed in side surfaces of the engaging portions (10a, 10b). The recesses (14a, 14b, 23a, 23b) are symmetrically arranged in the left and right engaging portions (10a, 10b). Transversely symmetrical identification pieces (19a, 19b) project from the leading ends of terminals (15a, 15b). In the case of a correct correspondence of the electrodes (11a, 11b) and the terminals (15a, 15b), the identification pieces (19a, 19b) fit into the recesses (14a, 14b, 23a, 23b), enabling assembling of the terminals (15a, 15b) with the electrodes (11a, 11b). In the case of an incorrect correspondence, the identification pieces (19a, 19b) cannot be fitted into the recesses (14a, 14b, 23a, 23b) and interfere with the upper surface of the battery (B), making assembling impossible.

### BACKGROUND OF THE INVENTION

1. Field of the Invention

The present invention relates to a construction for preventing erroneous assembling of battery terminals. The invention also relates to a battery and to a set of terminals for connection with the battery.

2. Description of the Related Art

Shafts project from the upper surface of an automotive battery as a (+)-electrode and a (−)-electrode. The shafts can be inserted into round holes of terminals connected with a battery cord and the terminals can be fastened to the shafts with nuts or the like.

However, the battery terminals are substantially identical, and hence are connectable with either one of the electrodes. Accordingly, the battery terminals may be connected with incorrect electrodes.

The present invention was developed in view of the above situation and an object of the invention is to provide a construction capable of preventing erroneous assembling of battery terminals. Another object of the invention is to provide a battery and a set of terminals for connection therewith.

### SUMMARY OF THE INVENTION

The invention is directed to a construction for preventing erroneous assembling of battery terminals, and hence for correctly assembling the terminals with a corresponding (−)-electrode and (+)-electrode of a battery. The two terminals and the two electrodes comprise identification means for enabling assembling only if a correct correspondence exists between the terminals and the electrodes, while preventing assembly of the terminals with the electrodes if there is incorrect correspondence.

The identification means may comprise identification pieces symmetrically formed on both terminals, and transversely symmetrical engaging portions formed near the electrodes of the battery. The identification pieces can be fit on or inserted in the engaging portions of the electrodes. Thus, an attempt to connect the terminals with the wrong electrodes will produce interference between the identification pieces and the engaging portions and will prevent the terminals and electrodes from being assembled. However, terminals and electrodes that correspond correctly can be connected because the identification pieces can be fit on or inserted in the engaging portions. Additionally, the identification means on the battery can be distinguished easily in appearance from electrodes of existing standards.

The identification means of the electrodes may comprise a threaded shaft on one electrode and a nut in the other electrode. The identification means of the terminals comprises a nut in the terminal that corresponds to the electrode with the threaded shaft, and hence that terminal can be screwed down on the threaded shaft. Conversely, a threaded shaft is provided in the terminal that corresponds to the electrode with the nut. Hence that terminal can be engaged with the nut of the corresponding electrode. Accordingly, an incorrect correspondence between terminals and electrodes, results in a combination of the threaded shafts or a combination of nuts. Thus, the terminals and the electrodes cannot be assembled.

The identification means of the electrodes also may comprise threaded shafts of different diameters and a key-receiving portion formed around or near the electrode with the thicker threaded shaft. The identification means of the terminals may comprise insertion holes having different diameters for enabling insertion of the threaded shafts. A key may be formed on the terminal with the larger insertion hole and may be fit in a key-receiving portion. The terminal with the smaller insertion hole cannot be assembled with the electrode that has the thicker threaded shaft. The terminal with the larger insertion hole theoretically can be assembled with the electrode that has the thinner threaded shaft. However, the key interferes with part of the battery. Accordingly, insertion of the thinner threaded shaft into the larger insertion hole is impossible. The correct terminals can be assembled with the electrodes because the key fits into the key-receiving portion.

The identification means of the terminals also may comprise a cover that is mounted on or over the terminal. The identification means of the electrodes may comprise a terminal-accommodating portion for accommodating the terminal with the cover by conforming to the cover if a correct correspondence between the terminals and the electrodes exists. However, the identification means may make it impossible to connect the terminals with the incorrect electrodes by causing the cover to interfere with the battery. Accordingly, erroneous assembling of the terminal that has the cover with the wrong electrode can be avoided by the identification means of the electrode.

The electrodes may comprise engaging portions in the form of recesses around the threaded shafts of the electrodes and identification recesses formed in wall surfaces of the engaging portions. The terminals may comprise identification pieces that do not fit into the identification recess of the incorrect electrode and that are formed in different positions in the terminals. Accordingly, the identification recesses and the identification pieces interfere with each other to make assembling impossible in the case of the incorrect correspondence between the terminals and the electrodes.

Incorrect correspondence prevents complete assembly of the terminal with the electrode for each of the above-described embodiments. An operator can notice the incorrect correspondence and can make corrections.

The construction may further comprise rotation-preventing means for preventing rotation of the terminals with respect to the corresponding electrodes. The rotation preventing means prevents rotation during fastening and enables fastening to be performed smoothly. For example, the electrodes may have identification recesses and the terminals may have rotation preventing pieces that project in positions different from the identification pieces. The rotation preventing pieces fit into the identification recesses when there is correct correspondence between the terminals and the electrodes. This contact of the rotation preventing pieces with wall surfaces of the identification recesses prevents rotation of the entire terminals during fastening with the nuts.

The rotation preventing means may comprise the identification pieces. More particularly, the identification pieces may fit into the identification recesses when there is correct correspondence between the terminals and the electrodes to prevent rotation of the terminals relative to the electrodes. However, the identification pieces may be unable to fit into the identification recesses due to interference with the peripheries of the identification recesses when there is incorrect correspondence.

Contact pieces that can be brought into contact with wall surfaces of the identification recesses may be formed by bending edges of the identification pieces and/or the rotation preventing pieces forward with respect to the rotating directions of the terminals during fastening with the nuts. Thus, the contact area between the identification pieces and the identification recesses is increased and a rotation preventing function is enhanced.

A cover may be mounted on or over the terminal, and the identification piece and/or rotation preventing means of the terminal may project out of the cover. The projection of the identification piece from the cover prevents rotation and erroneous assembling regardless of whether the cover is mounted or not.

The invention also is directed to a battery having a (−)-electrode and a (+)-electrode. Corresponding terminals are connectable with the electrodes of the battery. The electrodes comprise identification means for enabling connection of terminals only in the case of a correct correspondence of the terminals and the electrodes. The identification means prevent assembly of the terminals with the electrode portions when there is incorrect correspondence.

Recesses may be formed around or near the electrodes and may have a depth so that the electrodes do not project to the upper surface of the battery. Accordingly, inadvertent contact of a tool or the like with the electrodes can be prevented.

The identification pieces may be formed symmetrically on both terminals, and/or the electrodes may be formed with symmetrical engaging portions in which the identification pieces may fit. Accordingly, the identification pieces and the engaging portions interfere with each other when there is incorrect correspondence, and connection of the terminals is impossible.

The invention also is directed to a set of terminals that are connectable at least with corresponding (−)-electrode and (+)-electrodes of a battery. The terminals comprise identification means for enabling connection of terminals only in the case of a correct correspondence of the terminals and the electrodes and prevent assembly of the terminals with the electrodes when there is incorrect correspondence.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is an exploded perspective view showing an assembling construction of a first embodiment.

FIG. 2 is a plan view showing an assembled state of an engaging portion and a terminal.

FIG. 3 is a side view showing the assembled state of the engaging portion and the terminal.

FIG. 4 is an exploded perspective view showing an assembling construction of a second embodiment.

FIG. 5 is a plan view showing an assembled state of an engaging portion and a terminal.

FIG. 6 is an exploded perspective view showing an assembling construction of a third embodiment.

FIG. 7 is a plan view showing an assembled state of an engaging portion and a terminal.

FIG. 8 is an exploded perspective view showing an assembling construction of a fourth embodiment.

FIG. 9 is a plan view showing an assembled state of an engaging portion and a terminal.

FIG. 10 is a side view of a cover with a second lid left open.

FIG. 11 is an exploded perspective view showing an assembling construction of a fifth embodiment.

FIG. 12 is a plan view showing an assembled state of an engaging portion and a terminal.

FIG. 13 is a side view showing the assembled state of the engaging portion and the terminal.

FIG. 14 is a plan view showing a case of erroneous assembling.

FIG. 15 is an exploded perspective view showing an assembling construction of a sixth embodiment, FIG. 16 is a plan view showing an assembled state of an engaging portion and a terminal.

FIG. 17 is a plan view showing a case of erroneous assembling,

FIG. 18 is an exploded perspective view showing an assembling construction of a seventh embodiment,

FIG. 19 is a plan view showing an assembled state of an engaging portion and a terminal, and

FIG. 20 is a side view of a cover with a second lid left open.

### DETAILED DESCRIPTION OF THE PREFERRED EMBODIMENTS

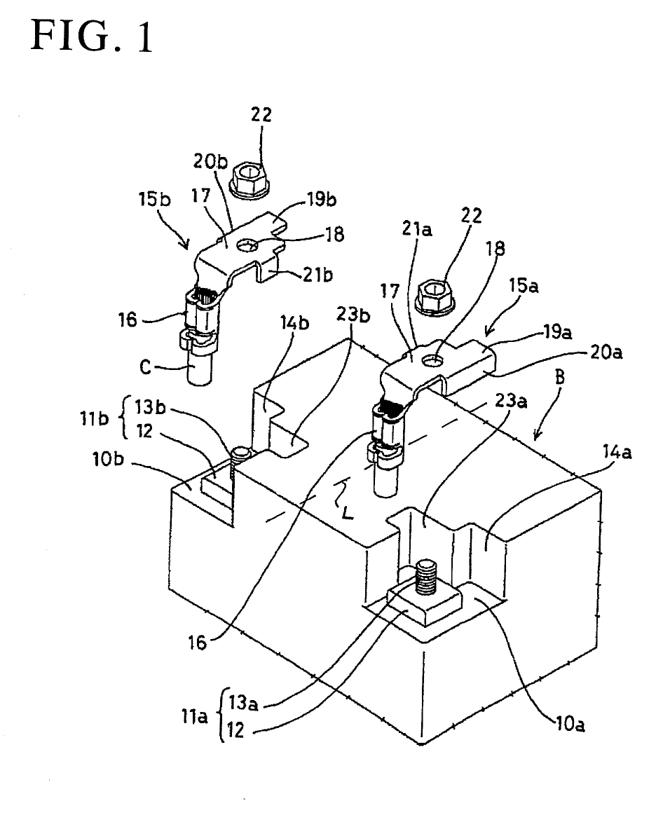

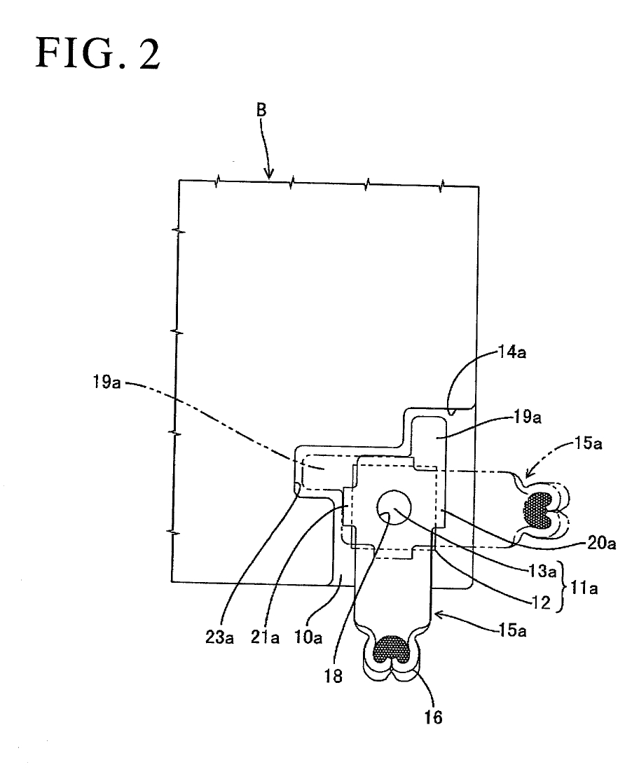

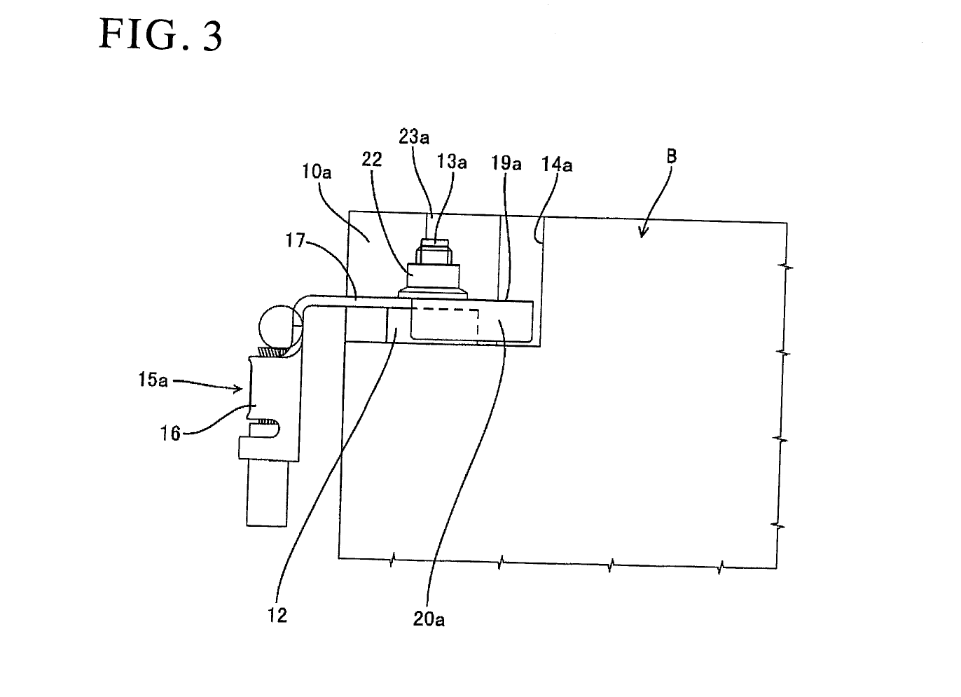

The letter B in FIGS. 1-3 identifies a battery in accordance with the invention. The illustrated battery B is e.g. a 36V-battery (usually 12V-battery). Left and right corners of the battery B are recessed to form engaging portions 10a, 10b, as shown in FIG. 1, and a (+)-electrode 11a and a (−)-electrode 11b are provided on the bottom surfaces of the engaging portions 10a, 10b. The electrodes 10a, 10b have threaded shafts 13a, 13b that project vertically or substantially normal from central positions on washers 12. The washers 12 shown in FIG. 1 are in the form of a square flat plates. The depth of the engaging portions 10a, 10b is set such that the threaded shafts 13a, 13b do not project to the upper surface of the battery B. Further, first and second recesses 14a and 23a are formed in two lateral walls of the engaging portion 10a, and similar recesses 14b and 23b are formed in two lateral walls of the engaging portion 10b. The corresponding recesses 14a, 23a and 14b, 23b of the engaging portions 10a, 10b are transversely symmetrical such that the recessing directions of the corresponding recesses 14a, 23a and 14b, 23b are substantially normal to each other, as shown in FIG. 2. The recesses 14a and 14b as well as 23a and 23b are preferably substantially symmetrical with respect to a line L that extends transversely between the electrodes 11a, 11b.

Terminals 15a and 15b are connectable with the electrodes 11a and 11b respectively. The terminals 15a and 15b are made of a conductive metallic material and each has a barrel 16 at its rear end for connection of a battery cord C, preferably by crimping. Base plates 17 are formed at front portions of the terminals 15a, 15b and are bent at an angle different from 0° or 180°, preferably substantially at a right angle to the barrels 16. Each base plate 17 is formed in its middle with an insertion hole 18 through which the threaded shaft 13a, 13b can be inserted. The base plates 17 of the left and right terminals 15a, 15b are formed to be transversely symmetrical or symmetrical with respect to the line L when fitted on the battery B. Specifically, identification pieces 19a and 19b project forward from the leading ends of the base plates 17 of the respective terminals 15a, and 15b. The identification pieces 19a, 19b have substantially half the width of the leading edge of the base plates 17, and can be fit into the first or second recesses 14a, 14b, 23a, 23b (see FIG. 2). The identification pieces 19a, 19b of the left and right terminals 15a, 15b also are formed to be transversely symmetrical or symmetrical with respect to the line L when fitted on the battery B. The identification pieces 19a, 19b interfere with the upper surface of the battery B to prevent the terminals 15b, 15a from being assembled with the incorrect electrodes 11a, 11b. However, if a correspondence between the terminals 15a, 15b and the electrodes 11a, 11b is correct, the identification pieces 19a, 19b fit into the first or second recesses 14a, 14b, 23a, 23b, enabling connection of the terminals 15a, 15b with the electrodes 11a, 11b. Thus, the identification pieces 19a, 19b and the recesses 14a, 14b, 23a, 23b define identification means.

Sides of the terminals 15a, 15 from the identification pieces 19a, 19b to the base plates 17 are bent down at an angle different from 0° or 180°, preferably substantially at right angles, to form first rotation preventing pieces 20a, 20b. Sides of the base plates 17 opposite the first rotation preventing pieces 20a, 20b also are bent down substantially at right angles, to form second rotation preventing pieces 21a, 21b that preferably have shorter lengths than the first rotation preventing pieces 20a, 20b. The washers 12 are held tightly by or interact with the first and second rotation preventing pieces 20a, 20b, 21a and 21b. As a result, rotation of the terminals 15a, 15b is prevented when nuts 22 are screwed down on the threaded shafts 13a, 13b.

The terminals 15a and 15b can be mounted onto the correct electrodes 11a and 11b so that the identification pieces 19a and 19b fit tightly into the first or second recesses 14a, 14b, 23a or 23b. The threaded shafts 13a and 13b then are inserted into the insertion holes, and the washers 12 are held tightly by or interact with the first and second rotation preventing pieces 20a, 20b, 21a and 21b. The nuts 22 then are screwed down on the threaded shafts 13a, 13b with the base plates 17 and the washers 12 held in close contact. Thus, rotation of the terminals 15a, 15b is prevented by the rotation preventing pieces 20a, 20b, 21a, 21b. In this way, connection of the terminals 15a, 15b with the correctly corresponding electrodes 11a, 11b is completed.

In the case of an incorrect correspondence between the terminals 15a, 15b and the electrodes 11a, 11b, the identification pieces 19a, 19b will not fit into either the first or second recesses 14a, 14b, 23a and 23b and interfere with the upper surface of the battery B. As a result, the terminals 15a, 15b cannot be assembled with the engaging portions 10a, 10b. Thus, an operator can immediately notice an incorrect arrangement of the terminals 15a, 15b.

As described above, erroneous assembling of the terminals 15a, 15b can be prevented by transversely symmetrically forming the identification pieces 19a, 19b and the recesses 14a, 14b, 23a, 23b in the first embodiment. Further, since the battery B according to this embodiment has a special form in which the engaging portions 10a, 10b are formed around the electrodes 11a, 11b, it contributes to distinction from conventional 12V-batteries. Furthermore, since the depth of the engaging portions 10a, 10b is set such that the threaded shafts 13a, 13b do not project to the upper surface of the battery B, inadvertent contact of a tool or the like with the threaded shafts is avoided.

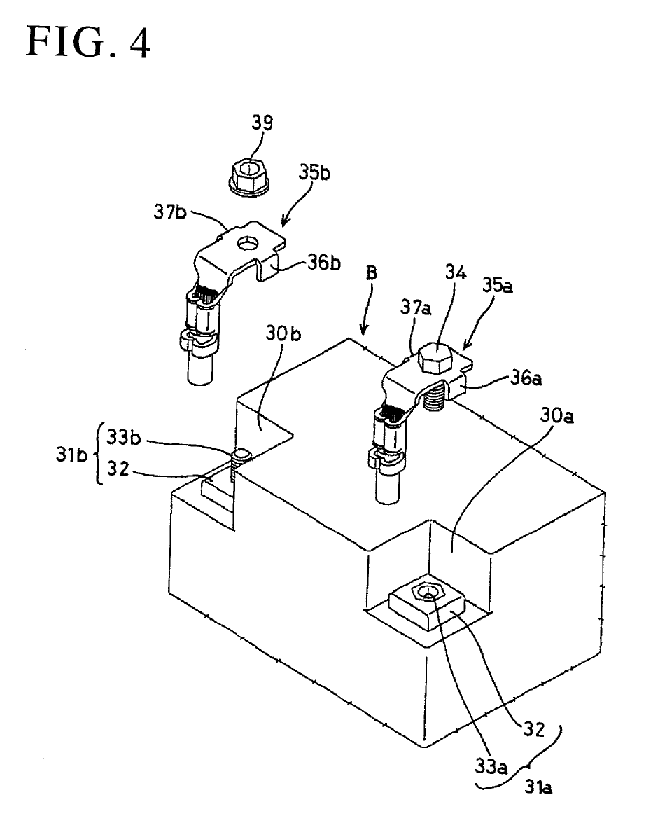

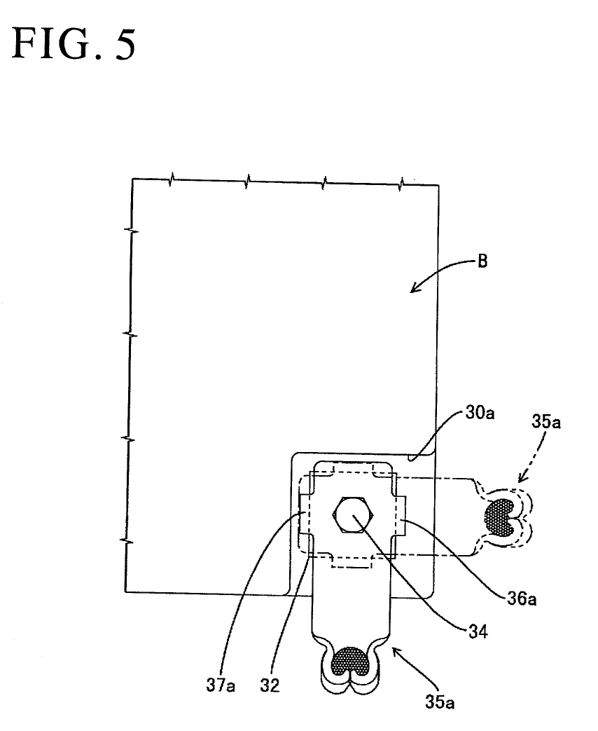

The letter B in FIGS. 4 and 5 identifies a battery in accordance with a second embodiment of the invention. The battery B has a first electrode 31b with a threaded shaft similar to the electrodes of the first embodiment. However, the second electrode defines a nut 33a embedded in a washer 32. The electrodes 31a, 31b are in substantially rectangular recesses 30a, 30b, but without the recesses 14a, 14b, 23a and 23b of the first embodiment. Accordingly, the terminals 35a and 35b do not have identification pieces, but are formed with rotation preventing pieces 36a 36b or 37a, 37b for tightly holding the washers 32. A bolt 34 is held rotatably on the terminal 35a by a temporary locking mechanism (not shown). The temporary locking mechanism may be a frangible weld between the lower surface of a head of the bolt 34 and a base plate of the terminal 35a. The weld may be sufficiently weak to break as the bolt 34 is screwed. The temporary locking mechanism also may be a claw at the edge of the insertion hole for softly engaging a thread of the bolt. Alternatively, the bolt 34 may be formed with a recess that engages the base plate of the terminal 35a to allow further rotation of the bolt 34 while longitudinally or axially holding the bolt 34 with respect to the base plate.

A nut 39 can be used to fasten the terminal 35b to the threaded shaft 33a of the electrode 31b, if there is correct correspondence between the terminals 35a, 35b and the electrodes 31a, 31b. Similarly, this correct correspondence enables the bolt 34 of the terminal 35 to be fastened to the nut 33b of the electrode 31b.

Incorrect correspondence between the terminals 35a, 35b and the electrodes 31a, 31b will align the bolt 34 of the terminal 35a with the threaded shaft 33b of the electrode 31b. Similarly, incorrect correspondence will align the terminal 35b, which should be fastened by the nut 39, with the embedded nut 33a of the electrode 31a. Connection is impossible with either combination, and an operator immediately knows the erroneous assembly.

The temporary locking mechanism in this embodiment couples the bolt 34 to the terminal 35a. However, the nut 39 also may be coupled temporarily.

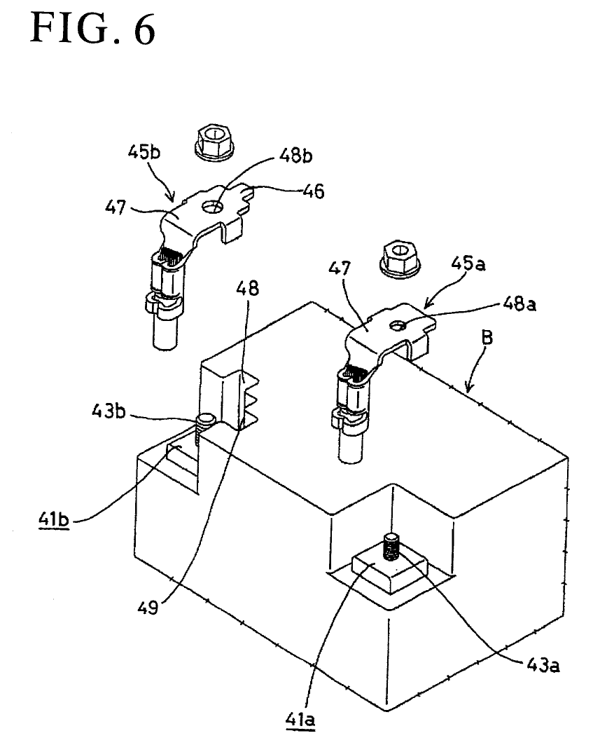

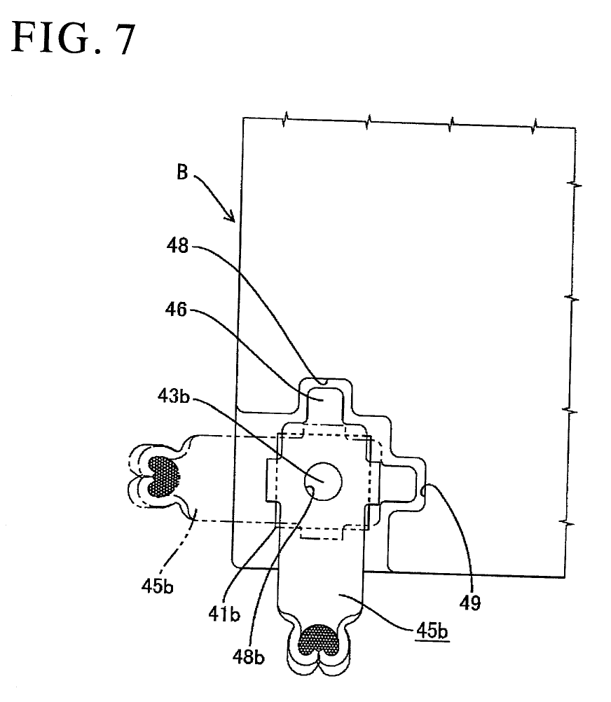

FIGS. 6 and 7 show a third embodiment of the present invention. Electrodes 41a, 41b in this embodiment are provided respectively with smaller and larger diameter threaded shafts 43a, 43b. Engaging portions are recessed in a depth direction similar to the first two embodiments, and two side walls of the left engaging portion in FIG. 6 are recessed to form first and second identical key receiving portions 48 and 49.

Insertion holes 48a, 48b pierce the base plates 47 of the terminals 45a, 45b and are provided respectively with smaller and larger diameters in conformity with the diameters of the threaded shafts 43a, 43b. A key 46 projects from the leading edge of the base plate 47 of the terminal 45b, and is dimensioned to fit into the key receiving portions 48, 49. The key 46 will interfere with the upper surface of the battery B and prevent the terminal 45b from being fit on the electrode 41a.

The terminal 45a with the smaller insertion hole 48a can be connected with the corresponding electrode 41a, in either of two optional positions, and preferably a position that matches either of the optional assembled positions of the other terminal 45b shown in FIG. 7.

The smaller insertion hole 48a of the terminal 45a cannot receive the thicker threaded shaft 43b of the electrode 41a. The thinner threaded shaft 43a of the electrode 41a can be inserted through the larger insertion hole 48b of the terminal 45b. However, the key 46 of the terminal 45a interferes with the upper surface of the battery B near the electrode 41a. As a result, the terminal 45b cannot be fit into the engaging portion of the electrode 41a. Accordingly, the third embodiment avoids erroneous assembly of the terminals 45a, 45b and the electrodes 41a, 41b.

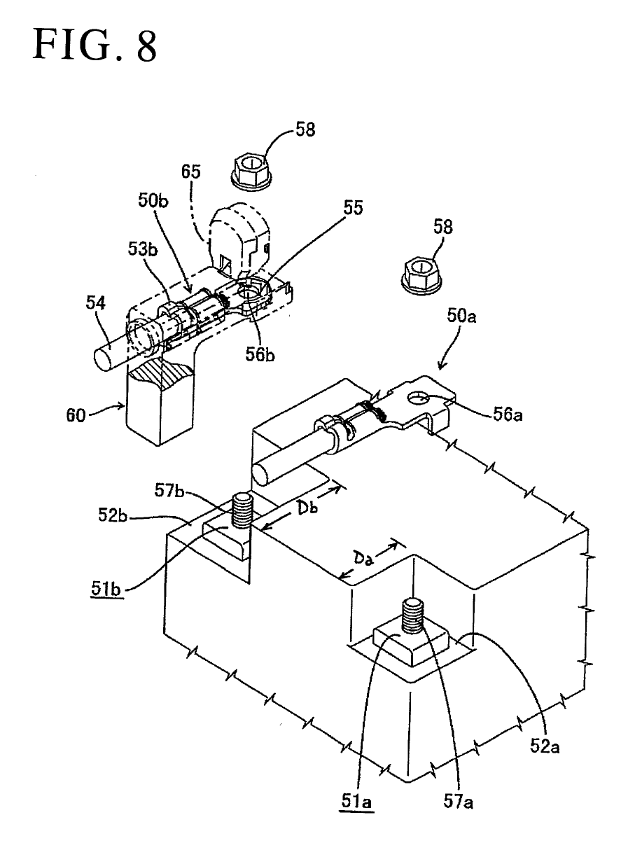

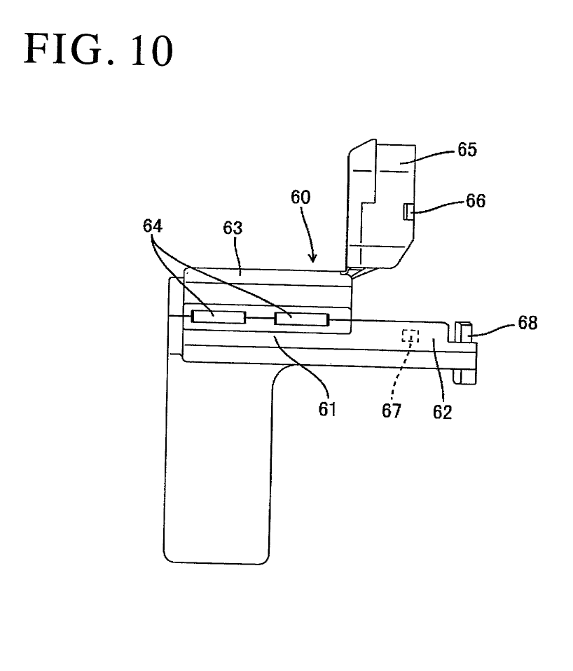

A fourth embodiment of the invention has a cover 60 placed over one terminal 50b, as shown in FIGS. 8-10, to differentiate the length of the terminal 50b from a terminal 50a that has no cover. Accordingly, the lengths Da, Db of terminal accommodating portions 52a, 52b formed around electrodes 51a, 51b are different. The different lengths Da, Db prevent the terminal 50b with the cover 60 from being fit into the terminal accommodating portion 52a. Specifically, the right terminal accommodating portion 52a around the electrode 51a in FIG. 8 is substantially square in plan view, whereas the left terminal accommodating portion 52b is an elongate rectangle.

The terminals 50a and 50b of FIGS. 8-10 are substantially the same as those of FIGS. 6 and 7. However, barrels preferably are formed straight without being bent in this embodiment.

The cover 60 is integrally or unitarily made of an insulating material and is mounted on the terminal 50b for the (+)-electrode 51b in FIG. 8. The cover 60 comprises a barrel portion 61 for accommodating both the barrel 53b of the terminal 50b and part of the battery cord 54, and a connector portion 62 for accommodating a connector 55 that connects with the electrode 51b. A first lid 63 is hinged to the barrel portion 61 of the cover 60, and pivots to open and close the connector portion 62. Two locking claws 64 are formed at an edge of the barrel portion 61 opposite the hinge and are locked into engagement with a base end of the barrel portion 61 when the first lid 63 is closed. A second lid 65 is hinged to the first lid 63 for opening and closing the connector 55 of the terminal 50b. Locking projections 66 on the first lid 65 engage corresponding locking recesses 67 to lock the second lid 65 and to cover substantially the entire surface of the connecting portion 55 of the terminal 50b. A stopper 68 projects at the leading end inside the connector portion 62, and can contact the leading end of the terminal 50b to position the terminal 50b being accommodated. The bottom wall of the connector portion 62 has an unillustrated through hole that is alignable with an insertion hole 56b of the terminal 50b. Thus a threaded shaft 57b of the electrode portion 51b can be inserted through the insertion hole 56b via this through hole.

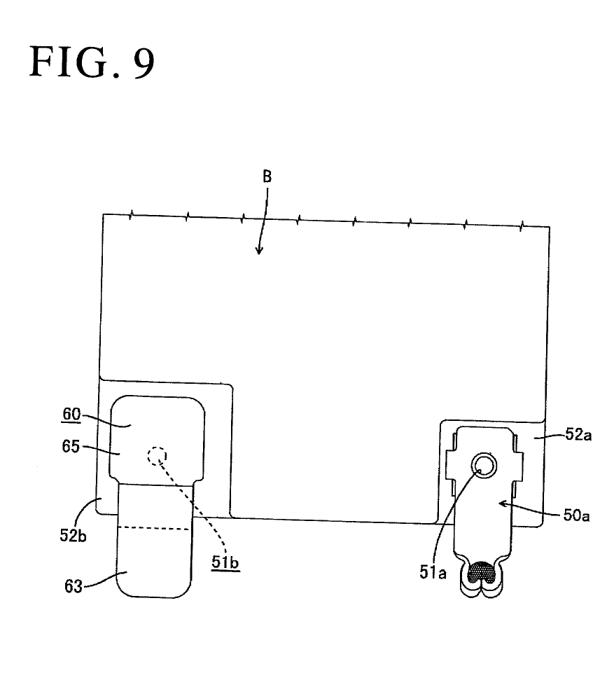

The distance from the center of the insertion hole 56b of the terminal 50b to the front edge of the cover 60 is longer than the distance from the center of an insertion hole 56a to the front end of the terminal 50a. Thus, the terminal 50b and the cover 60 can be fit into the left terminal accommodating portion 52b shown in FIGS. 8 and 9 and connected with the electrode portion 51b. However, the terminal 50b cannot be fit into the smaller terminal accommodating portion 52a because the leading end of the cover 60 will interfere with the upper surface of the battery B. Thus, it is impossible to fit the terminal 50b into the terminal accommodating portion 52a, and an operator will notice the erroneous assembly.

Connection of the terminal 50a is completed by inserting the threaded shaft 57a at the right side of FIGS. 8 and 9 through the insertion hole 56a of the terminal 50a and screwing the nut 58 down on the threaded shaft 57a. The cover 60 then is mounted on the terminal 50b and the battery cord 54 with the second lid 65 of the cover 60 open. The threaded shaft 57b at the left side of FIGS. 8 and 9 then is inserted through the insertion hole 56b via the through hole and the nut 58 is screwed onto the threaded shaft 57b. The second lid 65 then is closed and the locking projections 66 engage with the locking recesses 67 to hold the second lid 65 closed.

The terminal 50b provided with the cover 60 cannot be fit into the right terminal accommodating portion 52a in FIGS. 8 and 9 because the leading end of the cover 60 interferes with the upper surface of the battery B due to the smaller dimensions of the right terminal accommodating portion 52a. Additionally, the threaded shaft 57b will not match the through hole if an attempt is made to fit the terminal 50b into the terminal accommodating portion 52a at an angle that might avoid interference of the cover 60 with the upper surface of the battery B. Therefore, erroneous assembling can be avoided in this embodiment.

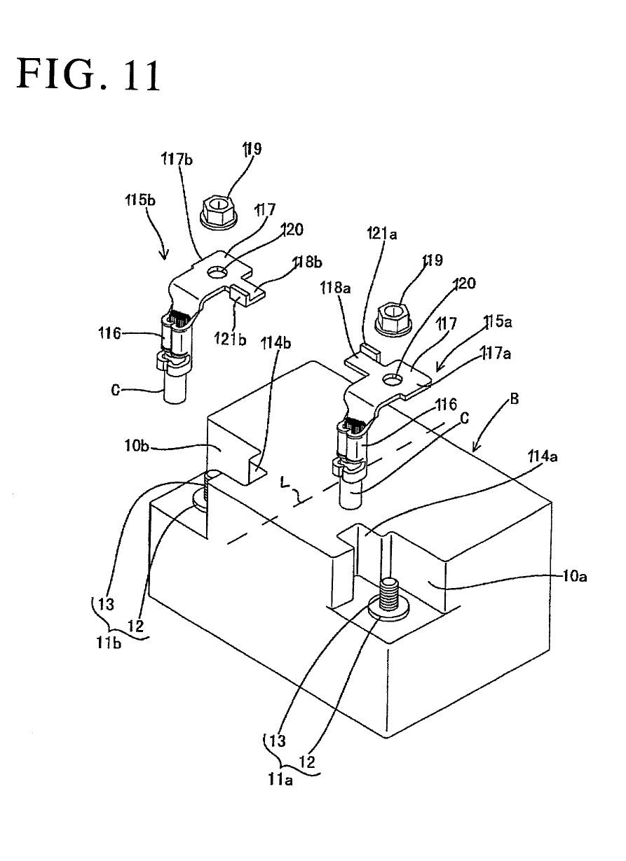

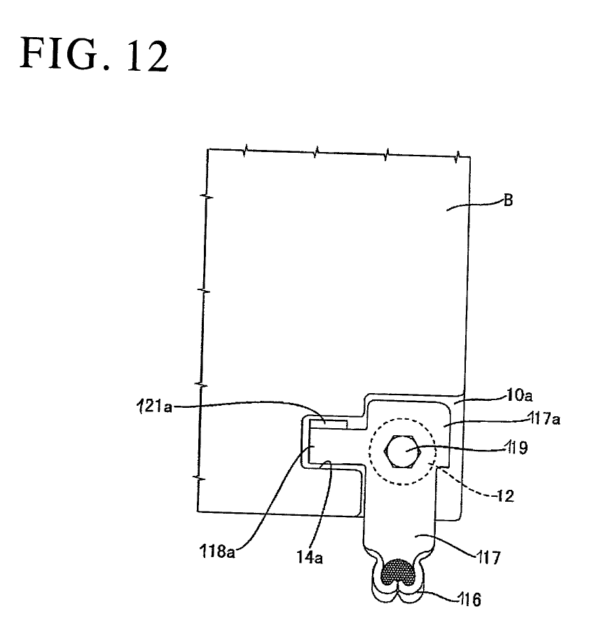

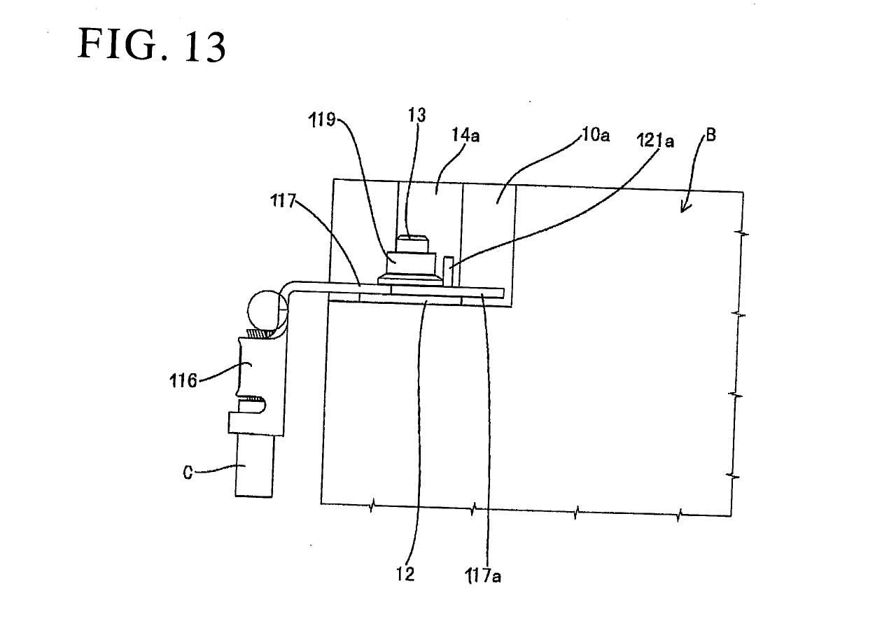

The letter B in FIGS. 11-14 identifies a battery in accordance with a fifth embodiment of the invention. As in the previous embodiments, left and right corners of the battery B form recessed engaging portions 10a, 10b, which are provided respectively with a (+)-electrode 11a and a (−)-electrode 11b. The electrodes 10a, 10b have threaded shafts 13a, 13b that project substantially vertically through washers 12. The depth of the engaging portions 10a, 10b exceeds the height of the threaded shafts 13a, 13b, and hence the shafts 13a, 13b do not project to the upper surface of the battery B. Transversely symmetrical identification recesses 114a, 114b are formed in side walls of the respective engaging portions 10a, 10b, and extend inwardly toward each other. Thus, the identification recesses 114a, 114b are substantially symmetrical with respect to a transverse line L between the electrodes 11a, 11b.

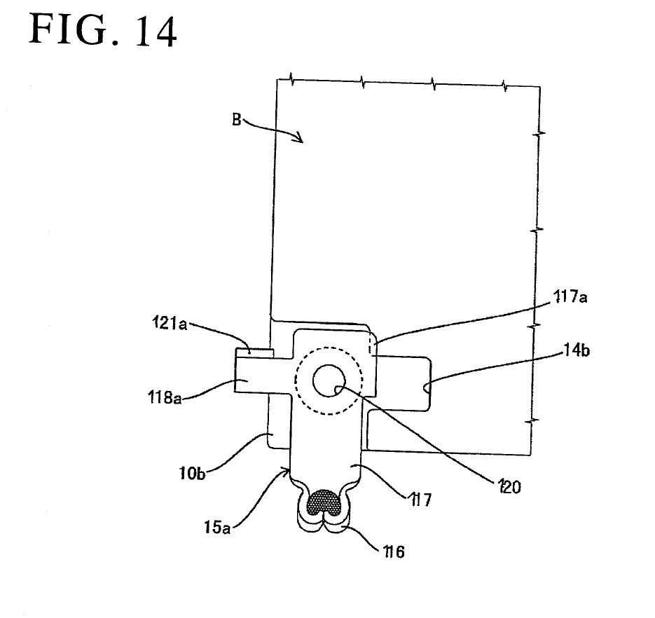

Terminals 15a, 15b are connectable with the electrodes 11a, 11b. The terminals 15a and 15b are made of a conductive metal and each has a barrel 16 at its rear end for crimped connection to a battery cord C. Base plates 117 are formed at the fronts of the terminals 15a, 15b and are bent substantially at right angles to the barrels 16. The middle of each base plate 117 has an insertion hole 120 that is dimensioned to receive one of the threaded shafts 13a, 13b. The base plates 117 of the left and right terminals 15a, 15b are formed to be transversely symmetrical. Specifically, transversely symmetrical identification pieces 117a, 117b project from side edges of the base plates 117 of the respective terminals 15a, 15b. The width of each identification piece 117a, 117b exceeds the width of the identification recesses 114a, 114b. Thus, if an attempt is made to assemble the terminals 15a, 15b and the electrodes 11a, 11b in an incorrect correspondence, the identification pieces 117a, 117b and the identification recesses 114a, 114b interfere with each other as shown in FIG. 14, and prevent assembly of the terminals 15a, 15b.

Rotation preventing pieces 118a, 118b project from side edges of the base plates 117 opposite from the identification pieces 117a, 117b. The rotation preventing pieces 118a, 118b are narrower than the identification pieces 117a, 117b and can be fit into the identification recesses 114a, 114b when the terminals 15a, 15b and the electrodes 11a, 11b correspond correctly. Thus, the terminals 15a, 15b will not rotate as the nuts 119 are tightened onto the threaded shafts 13. Contact pieces 121a, 121b are bent upward along side edges of the rotation preventing pieces 118a, 118b that are forward with respect to the rotating directions of the nuts 119. The contact pieces 121a, 121b enlarge contact areas with the identification recesses 114a, 114b and prevent damage to the battery B.

The rotation preventing pieces 118a, 118b of the terminals 15a, 15b fit into the corresponding identification recesses 114a, 114b if there is correct correspondence between the terminals 15a, 15b and the electrodes 11a, 11b. The threaded shafts 13 then are inserted into the insertion holes 120 and the base plates 117 are placed on the washer rings 12, such that the barrels 16 of the terminals 15a, 15b and the battery cords C extend substantially along side surfaces of the battery B. Connections of the terminals 15a, 15b are completed by screwing the nuts 119 onto the threaded shafts 13. The terminals 15a, 15b try to rotate clockwise at a final stage of fastening. However, the contact pieces 121a, 121b of the rotation preventing pieces 118a, 118b contact the facing surfaces of the identification recesses 114a, 114b to prevent rotation. Thus, fastening with the nuts 119 can be performed smoothly.

An incorrect correspondence between the terminals 15a, 15b and the electrodes 11a, 11b will cause the identification pieces 117a, 117b to interfere with the opening edges of the identification recesses 114a, 114b, as shown in FIG. 14. As a result, the terminals 15a, 15b cannot fit into the engaging portions 10a, 10b. An operator will notice this incorrect correspondence between the terminals 15a, 15b and the electrodes 11a, 11b.

Correct or incorrect correspondence between the terminals 15a, 15b and the electrodes 11a, 11b can be determined based on whether the identification pieces 117a, 117b interfere with the upper surface of the battery B. Further, the rotating preventing pieces 118a, 118b engage the identification recesses 114a, 114b to prevent rotation of the terminals during fastening with the nuts 119. Thus, fastening can be performed smoothly and easily. Furthermore, the contact pieces 121a, 121b enlarge the contact areas with the walls of the identification recesses 114a, 114b. Thus the rotation preventing pieces 117a, 117b will not bite in the walls of the identification recesses 114a, 114b, thereby protecting the battery B from damage or scratches.

The battery B of this embodiment has a special form in which the engaging portions 10a, 10b are formed around the electrodes 11a, 11b, to distinguish the battery B from conventional 12V-batteries. Furthermore, the depth of the engaging portions 10a, 10b is set such that the threaded shafts 13a, 13b do not project to the upper surface of the battery B. Thus, inadvertent contact of a tool or the like with the threaded shafts 113 is avoided.

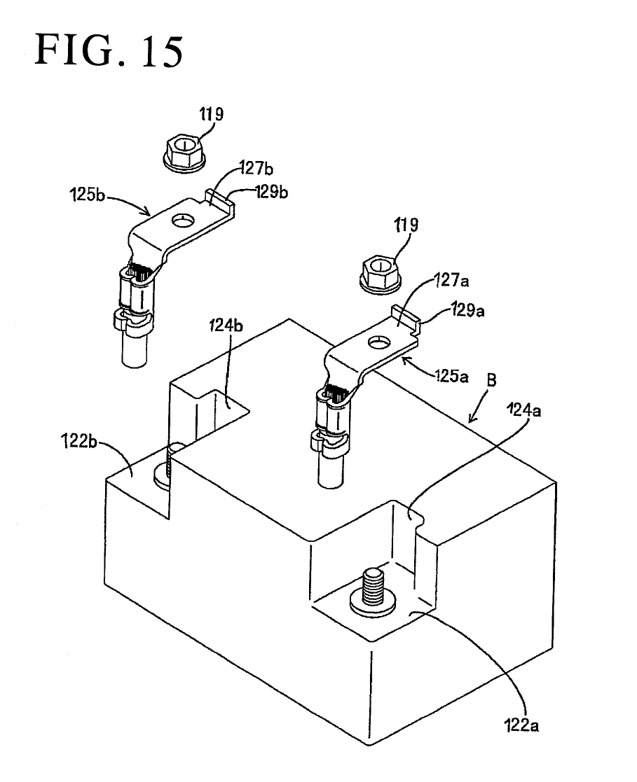

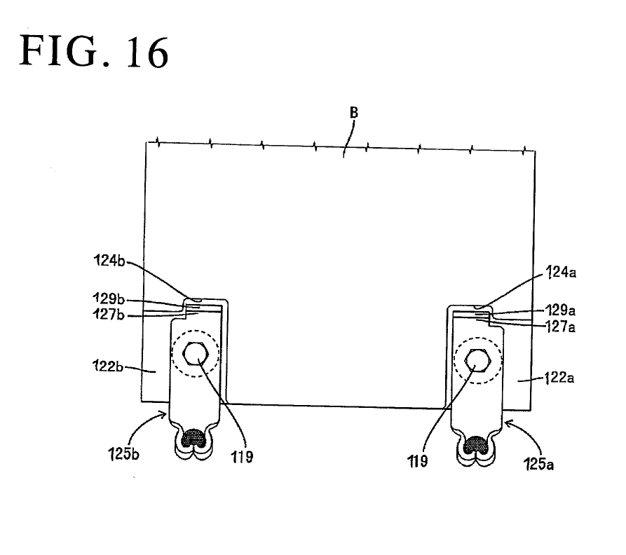

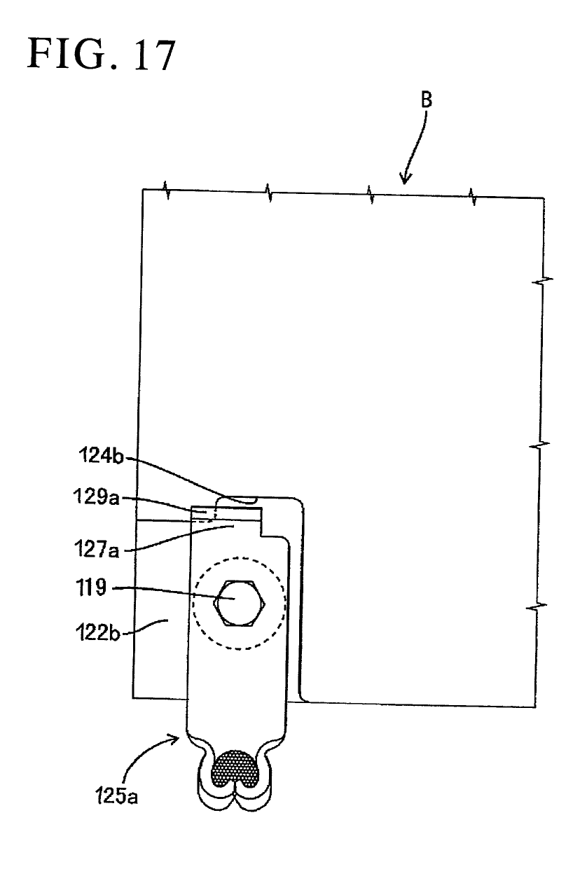

A sixth embodiment of the invention is shown in FIGS. 15-17 and has terminals 125a, 125b with identification pieces 127a, 127b that project from the leading edges of the terminals 125a, 125b in a longitudinal direction. The terminals 125a, 125b are transversely symmetrical, and each identification piece 127a, 127b is displaced toward one side edge of a base plate. Leading ends of the identification pieces 127a, 127b are bent upward to form contact pieces 129a, 129b. The contact pieces 121a, 121b were brought substantially into surface contact with the walls of the identification recesses 14a, 14b in the fifth embodiment. However, side edges of the contact pieces 129a, 129b are brought into contact with the walls of identification recesses 124a, 124b to prevent the rotation of the terminals 125a, 125b in the sixth embodiment.

Specifically, the identification recesses 124a, 124b are formed in the back or lateral walls of engaging portions 122a, 122b in positions substantially corresponding to the identification pieces 127a, 127b of the correctly arranged terminals 125a, 125b. Thus, the engaging portions 122a, 122b are transversely symmetrical. Other construction of the sixth embodiment is the same as or similar to the fifth embodiment.

The terminals 125a, 125b of the sixth embodiment cannot be connected with the incorrect electrodes 123a, 123b because the identification pieces 127a, 127b will not match the identification recesses 124a, 124b and will interfere with the peripheries of the identification recesses 124a, 124b. Rotation of the terminals 125a, 125b during fastening of the nuts 119 can be prevented by contact between the side edges of the contact pieces 129a, 129b and the walls of the identification recesses 124a, 124b during fastening of the nuts 119. Further, the constructions of the terminals and the battery can be simplified since the identification pieces 127a, 127b also act as rotation preventing pieces.

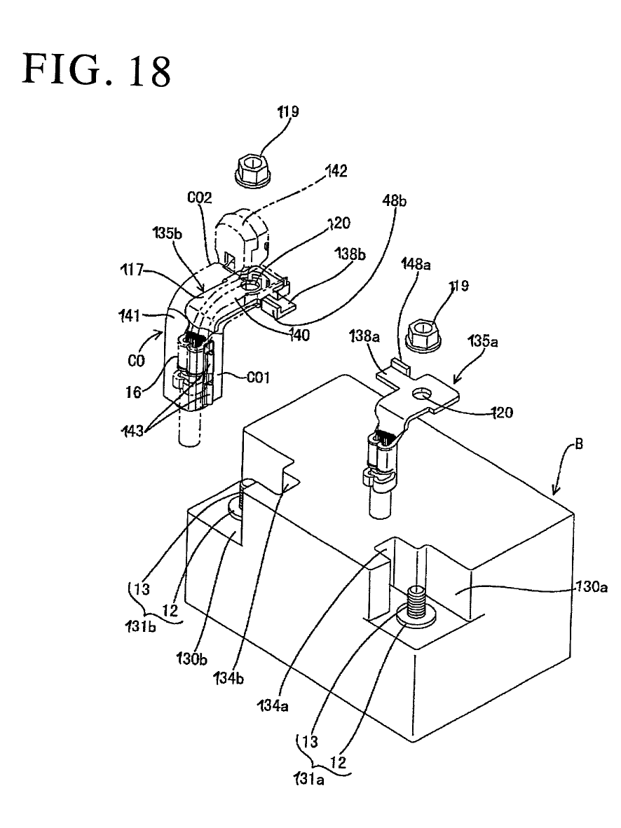

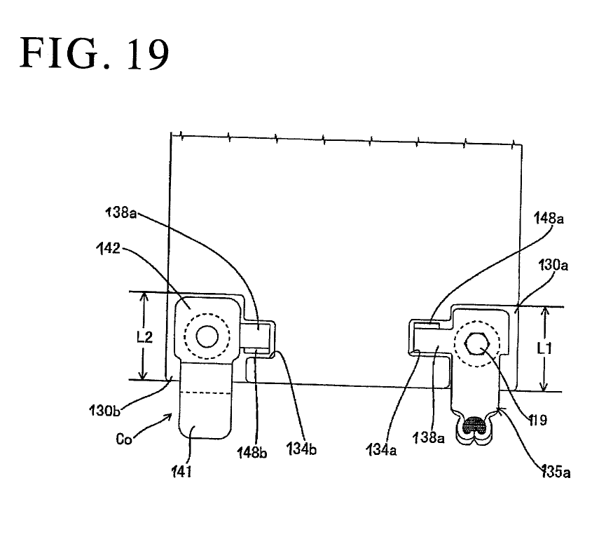

FIGS. 18 to 20 show a seventh embodiment of the invention. In the seventh embodiment, a cover CO is fit on or over one terminal 135b to differentiate the lengths of portions of the terminals to be accommodated in engaging portions 130a, 130b. More particularly, lengths of the engaging portions 130a, 130b differ (L1<L2), so that the terminal 135b provided with the cover CO cannot be fit into the engaging portion 130a in the case of an incorrect correspondence between the terminals 135a, 135b and electrode portions 131a, 131b.

The cover CO preferably is made integrally or unitarily of a synthetic resin and has a barrel portion CO1 for accommodating a barrel 16 of the terminal 135b and a part of a battery cord C. The cover CO also has a connecting portion CO2 that is continuous with and bent from the barrel portion CO1 and is adapted to accommodate a connector 140 for connection with the electrode 131b. The cover CO has a first lid 141 which is pivotal to open and close about a hinge at one edge extending from the barrel portion CO1 to the connecting portion CO2. Two locking claws 143 are formed at an edge of the barrel portion CO1 substantially opposite from the hinged edge and can be locked into engagement with a base end when the first lid 141 is closed.

The connecting portion CO2 has a second lid 142 for opening and closing the connector 140 of the terminal 135b. The second lid 142 is pivotal about a hinge 144 at a boundary with the first lid 141. Locking projections 145 are formed on the first lid 142 for engagement with corresponding locking recesses 146 to substantially close the second lid 142, thereby substantially covering the entire surface of the connector 140 of the terminal 135b.

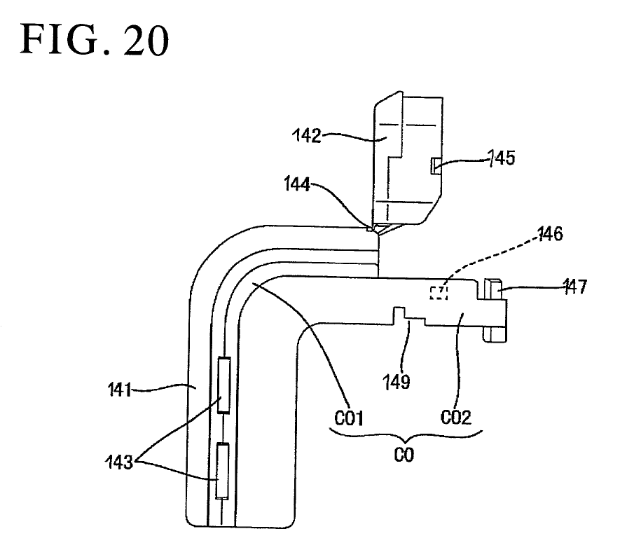

A stopper 147 projects at the leading end inside the connecting portion CO2 and contacts the leading end of the terminal 135b to position the terminal 135b being accommodated. The bottom wall of the connecting portion CO2 has an unillustrated through hole that aligns with an insertion hole of the terminal 135b, so that a threaded shaft 13 of the electrode portion 31b can be inserted through the insertion hole 120 via the through hole. As shown in FIG. 20, an escape hole 149 is formed in the bottom end of a side wall at a base of the connecting portion CO2 for drawing a rotation preventing piece 138b and a contact piece 148b of the terminal 135b out of the cover CO.

The terminal 135a can be connected as described above to the (−)-electrode at the right side in FIG. 18. The terminal 135b, on the other hand, can be accommodated in the cover CO with the first and second lids 141, 142 left open. The first lid 141 then can be closed and locked by the locking claws 143. At this stage, the rotation preventing piece 138b of the terminal 135b projects out of the cover CO through the escape hole 149. The threaded shaft 13 then is inserted through the insertion hole 120 via the unillustrated through hole in the bottom wall of the cover CO. The rotation preventing piece 138b then is fit into the identification recess 134b. Thereafter, the nut 119 can be screwed smoothly because rotation of the terminal is prevented by engagement of the contact piece 148b of the rotation preventing piece 138b with the wall. The second lid 142 then is closed to engage the locking projections 145 with the corresponding locking recesses 146, and the second lid 146 is held closed.

The terminal 135b provided with the cover CO cannot be fitted into the engaging portion 130a. More particularly, even if an attempt is made to adjust the position of the unillustrated through hole to match the position of the threaded shaft, the leading end of the cover CO interferes with the upper surface of the battery B due to an insufficient length of the engaging portion 130a at the side of the (−)-electrode. Therefore, erroneous assembling can be avoided with the seventh embodiment. Deformation of the cover CO can be prevented since a fastening torque of the nut 19 is received by the rotation preventing piece 138b drawn out of the cover CO in the seventh embodiment.

Various changes can be made in the present invention, and following embodiments are also embraced by the technical scope of the present invention as defined in the claims.

Although the identification means or rotation preventing means are formed both in the battery and in the terminals (including the cover CO) and are constructed by engagement of the recess and projection in any of the foregoing embodiments, these relationships are merely relative and not limited to those of the foregoing embodiments.

The identification recesses are not limited to those formed in the side walls of the engaging portions, and may be formed in the bottom surfaces thereof.

What is claimed is:

1. A construction for preventing erroneous assembling of two battery terminals (15; 35; 45; 50; 125; 135) and to correctly assemble the terminals (15; 35; 45; 50; 125; 135) with a corresponding (−)-electrode and (+)-electrode (11; 31; 41; 51; 122; 131) of a battery (B), wherein the terminals (15; 35; 45; 50; 125; 135) and the electrodes (11; 31; 41; 51; 122; 131) comprise identification means (19, 14, 23; 33, 34, 39; 43, 44, 46-49, 48; 52, 60; 118, 114; 117; 124, 127; 134, 138) for enabling assembling only in the case of a correct correspondence of the terminals (15; 35; 45; 50; 125; 135) and the electrodes (11; 31; 41; 51; 122; 131) while preventing assembly the terminals (15; 35; 45; 50; 125; 135) with the electrodes (11; 31; 41; 51; 122; 131) in the case of an incorrect correspondence.

2. A construction according to claim 1, wherein the identification means (19, 14, 23; 33, 34, 39; 43, 44, 46-49, 48; 52, 60; 118, 114; 117; 124, 127; 134, 138) comprise identification pieces (19; 118; 127; 138) symmetrically formed on both terminals (15; 125; 135), and transversely symmetrical engaging portions (14; 23; 114; 124; 134) are formed near the electrodes (11; 31; 41; 51; 122; 131) in the battery (B) and in which the identification pieces (19; 118; 127; 138) can be fit.

3. A construction according to claim 1, wherein the identification means (19, 14, 23; 33, 34, 39; 43, 44, 46-49, 48; 52, 60; 118, 114; 117; 124, 127; 134, 138) of the electrodes (11; 31; 41; 51; 122; 131) comprise a threaded shaft (33b) on a first of the electrodes (31b) and a nut (33a) on a second of the electrodes (31a), and the identification means (19, 14, 23; 33, 34, 39; 43, 44, 46-49, 48; 52, 60; 118, 114; 117; 124, 127; 134, 138) of the terminals (15; 35; 45; 50; 125; 135) comprise a nut (39) in the terminal (35b) corresponding to the first electrode (31b) having the threaded shaft (33b), such that the nut (39) can be screwed on the threaded shaft (33b), and a threaded shaft (34) on the terminal (35a) corresponding to the second electrode (31a) having the nut (33a), the threaded shaft (34) being engageable with the nut (33a) of the second electrode (31a).

4. A construction according to claim 1, wherein the identification means (19,14, 23; 33, 34, 39; 43, 44, 46-49, 48; 52, 60; 118, 114; 117; 124, 127; 134, 138) of the electrodes (11; 31; 41; 51; 122; 131) comprises a pair of threaded shafts (43a, 43b) having larger and smaller diameters respectively and a key receiving portion (48) formed near the electrode (41b) having the larger threaded shaft (43b), and the identification means (19, 14, 23; 33, 34, 39; 43, 44, 46-49, 48; 52, 60; 118, 114; 117; 124, 127; 134, 138) of the terminals (15; 35; 45; 50; 125; 135) comprises insertion holes (48a, 48b) having larger and smaller diameters for enabling insertion of the threaded shafts (43a, 43b) and a key (46) which is formed on the terminal (45b) having the larger insertion hole (48b), the key (46) being dimensioned to fit into the key receiving portion (48) and preventing assembly of the terminal (45b) having the larger insertion hole (48b) with the electrode (45b) by interfering with a part of the battery (B) if this terminal (45b) is connected with the electrode portion (41a) not corresponding thereto.

5. A construction according to claim 1, wherein the identification means (19, 14, 23; 33, 34, 39; 43, 44, 46-49, 48; 52, 60; 118, 114; 117; 124, 127; 134, 138) of the terminals (15; 35; 45; 50; 125; 135) comprises a cover (60; CO) mounted on one said terminal (50b; 135b).

6. A construction according to claim 5, wherein the identification means (19, 14, 23; 33, 34, 39; 43, 44, 46-49, 48; 52, 60; 118, 114; 117; 124, 127; 134, 138) of the electrodes (11; 31; 41; 51; 122; 131) comprises a terminal accommodating portion (52b; 130b) dimension for accommodating the terminal (50b; 135b) with the cover (60; CO) by corresponding to the cover (60; CO) in the case of a correct correspondence between the terminals (50; 135) and the electrodes (51; 131) while preventing connection of the terminals (50; 135) with the electrodes (51; 131) by causing the cover (60; CO) to interfere with the battery (B) in the case of an incorrect correspondence.

7. A construction according to claim 1, further comprising:
rotation preventing means (12, 21; 32, 36; 118, 114; 138, 134) for preventing rotation of the terminals (15; 35; 45; 50; 125; 135) with respect to the corresponding electrodes (11; 31; 41; 51; 122; 131) by mutual engagement.

8. A construction according to claim 7, wherein:
the electrodes (11; 31; 41; 51; 122; 131) comprise engaging recesses (10; 122; 130) around threaded shafts (11; 31; 41; 51; 122; 131) of the electrodes (11; 31; 41; 51; 122; 131) and identification recesses (114; 124; 134) formed in walls of the engaging recesses (10; 122; 130), and
the terminals (15; 35; 45; 50; 125; 135) comprise identification pieces (119; 117; 127) which do not fit into the identification recesses (114; 124; 134) due to interference with the identification recesses (114; 124; 134) and/or the battery (B) in the case of the incorrect correspondence between the terminals (15; 35; 45; 50; 125; 135) and the electrodes (11; 31; 41; 51; 122; 131) and are formed in different positions in the terminals (15; 35; 45; 50; 125; 135), and rotation preventing pieces (12, 21; 32, 36; 118, 114; 138, 134) projecting in positions different from the identification pieces (114; 124; 134), wherein, in the case of the correct correspondence between the terminals (15; 35; 45; 50; 125; 135) and the electrodes (11; 31; 41; 51; 122; 131), the rotation preventing pieces (12, 21; 32, 36; 118, 114; 138, 134) fit into the identification recesses (114; 124; 134) and prevent rotation of the terminals (15; 35; 45; 50; 125; 135) by the contact of the rotation preventing pieces (118, 114; 138, 134) with walls of the identification recesses (114; 124; 134) during fastening with nuts (22; 39;58; 119).

9. A construction according to claim 2, wherein, in the case of correct correspondence between the terminals (15; 35; 45; 50; 125; 135) and the electrodes (11; 31; 41; 51; 122; 131), the identification pieces (119; 117; 127) fit into the identification recesses (114; 124; 134) and prevent rotation of the terminals (15; 35; 45; 50; 125; 135) by contact of the rotation preventing pieces (118, 114; 138, 134) with walls of the identification recesses (114; 124; 134) during fastening with the nuts (22; 39;58; 119).

10. A construction according to claim 9, wherein contact pieces (121; 129) can be brought into contact with the walls of the identification recesses (114; 124; 134), the contact pieces (121;129) being formed by bending edges of the identification pieces (119; 117; 127) and the rotation preventing pieces (118, 114; 138, 134) and being located forward with respect to the rotating directions of the terminals (15; 35; 45; 50; 125; 135) during fastening with the nuts (22; 39;58; 119).

11. A construction according to claim 10, wherein a cover (CO) made of a synthetic resin is mounted on the terminal (135b), and the identification piece of the terminal (135b) projects out of the cover (CO).

12. A battery (B) having a (−)-electrode and a (+)-electrode (11; 31; 41; 51; 122; 131), corresponding terminals (15; 35; 45; 50; 125; 135) being connectable with both electrodes (11; 31; 41; 51; 122; 131) of the battery (B), wherein the electrodes (11; 31; 41; 51; 122; 131) comprise an identification means (14, 23; 33, 34, 39; 43, 44; 52; 114; 124; 134) for enabling connection of terminals (15; 35; 45; 50; 125; 135) only in the case of a correct correspondence of the terminals (15; 35; 45; 50; 125; 135) and the electrodes (11; 31; 41; 51; 122; 131) while preventing assembly of the terminals (15; 35; 45; 50; 125; 135) with the electrodes (11; 31; 41; 51; 122; 131) in the case of an incorrect correspondence.

13. A battery according to claim 12, wherein recesses (10; 30; 52; 130) are formed around the electrodes (11; 31; 41; 51; 122; 131) and have a depth such that the electrodes (11; 31; 41; 51; 122; 131) do not project to an upper surface of the battery (B).

14. A battery according to claim 13, wherein the electrodes (11; 31; 41; 51; 122; 131) are formed with symmetrical engaging portions (14; 23; 114; 124; 134) in which identification pieces (19; 118; 127; 138) symmetrically formed on both terminals (15; 35; 45; 50; 125; 135) can be fit.

15. A set of terminals (15; 35; 45; 50; 125; 135) connectable at least with a corresponding (−)-electrode and (+)-electrode (11; 31; 41; 51; 122; 131) of a battery (B), wherein the terminals (15; 35; 45; 50; 125; 135) comprise identification means (19, 14; 34, 39; 44, 46-49, 48; 60; 118; 117; 127; 138) for enabling connection of terminals (15; 35; 45; 50; 125; 135) only in the case of a correct correspondence of the terminals (15; 35; 45; 50; 125; 135) and the electrodes (11; 31; 41; 51; 122; 131) while preventing assembly of the terminals (15; 35; 45; 50; 125; 135) with the electrodes (11; 31; 41; 51; 122; 131) in the case of an incorrect correspondence.
